(19) United States
(12) Patent Application Publication
(10) Pub. No.: US 2013/0305731 A1
(43) Pub. Date: Nov. 21, 2013

(54) METHODS AND APPARATUS FOR PROVIDING FLUIDIC INSERTS INTO AN EXHAUST STREAM TO REDUCE JET NOISE FROM A NOZZLE

(71) Applicants: Philip John MORRIS, State College, PA (US); Dennis MCLAUGHLIN, State College, PA (US)

(72) Inventors: Philip John MORRIS, State College, PA (US); Dennis MCLAUGHLIN, State College, PA (US)

(21) Appl. No.: 13/894,050

(22) Filed: May 14, 2013

Related U.S. Application Data
(60) Provisional application No. 61/648,441, filed on May 17, 2012.

(51) Int. Cl. F02C 7/24

(52) U.S. Cl. CPC F02C 7/24
USPC 60/772; 60/725

(57) ABSTRACT

A method, an apparatus, and a computer program product are provided in connection reducing jet noise from a convergent-divergent nozzle that includes a divergent section through which at least portion of an exhaust gas flows at supersonic speeds. In one example, an apparatus is equipped with one or more injection ports arranged on the divergent section of the convergent-divergent nozzle, one or more delivery pipes coupled to each of the one or more injection ports on the exterior surface side of the divergent section and operable to transport an injection gas from a source to the divergent section through the one or more injection ports, and a controller operable to control at least one parameter associated with introduction of the injection gas. In an aspect, each of the one or more injection ports provides an opening from an interior surface to an exterior surface of the divergent section.

### CLAIM OF PRIORITY UNDER 35 U.S.C. §119

The present Application for Patent claims priority to Provisional Application No. 61/648,441 entitled “METHODS AND APPARATUS FOR PROVIDING FLUIDIC INSERTS INTO AN EXHAUST STREAM TO REDUCE JET NOISE FROM A NOZZLE” filed May 17, 2012, and assigned to the assignee hereof and hereby expressly incorporated by reference herein.

### BACKGROUND

The disclosed aspects relate to reduction of jet noise from a turbofan engine and particularly the use of fluidic inserts into a divergent section of a convergent-divergent nozzle to reduce noise.

Currently, low-bypass ratio high performance turbofan engines used on military fighter aircraft produce noise levels that are damaging to personnel and cause annoyance in communities around military bases. In high bypass ratio turbofan engines, used in the commercial fleet, the jet thrust is generated by exhausting a large mass flow of air at a relatively low velocity. Military fighter aircraft engines are low bypass ratio turbofan engines that generate thrust with a very high velocity and high temperature jet exhaust. One source of noise from these low bypass engines is the turbulent mixing of this high velocity flow with the surrounding air. Additionally, the engines often operate at an off-design condition where the pressure at the jet exit is different from the ambient pressure. This operation in an off-design condition leads to the occurrence of a shock cell structure in the jet exhaust in which alternating regions of different pressure and temperature occur as the jet pressure adjusts to that of the ambient air. The interaction of the turbulence in the jet shear layer with these shock cells is an additional source of noise called broadband shock-associated noise (BBSAN). Under some circumstances, particularly in twin jet exhaust configurations, a resonant phenomenon called screech can occur, resulting in intense pressure fluctuations in an area between the engines that can result in structural damage.

Various noise reduction concepts have been attempted in this field with varying degrees of success. For example, a water injection concept was shown to generally work, but the need to carry large quantities of water exceeds practical capabilities (to date). In another example, a flexible filament concept produced noise reductions but the gains were made predominantly by suppressing screech in cold jets which is of minimal practical interest in hot exhaust jets. In another example, exhaust nozzle chevrons introduce longitudinal vortices into the jet shear annulus that increases the mixing and shortens the high velocity/turbulence length of the jet. This results in noise reduction with only a small performance penalty. Although the concept is quite simple, the numerous variations of the shape parameters require substantial analysis and experimentation to produce designs of acceptable performance. In another example, the use of corrugated seal inserts changes the area ratio of the nozzle resulting in a weakening of the shock cell structure responsible for the shock noise. In addition, the induced stream-wise vortices appear to reduce the large scale structure noise in the same way chevrons do. But, the presence of the corrugated seal inserts degrades performance at the higher pressure ratio conditions found in cruise (and at altitude).

As such, a system and method to efficiently reduce jet noise from a convergent-divergent nozzle that is coupled to a turbofan engine may be desired.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In accordance with one or more aspects and corresponding disclosure thereof, various aspects are described in connection with reducing jet noise from a convergent-divergent nozzle that includes a divergent section through which at least portion of an exhaust gas flows at supersonic speeds. In one example, an apparatus is equipped with one or more injection ports arranged on the divergent section of the convergent-divergent nozzle, one or more delivery pipes coupled to each of the one or more injection ports on the exterior surface side of the divergent section and operable to transport an injection gas from a source to the divergent section through the one or more injection ports, and a controller operable to control at least one parameter associated with introduction of the injection gas. In an aspect, each of the one or more injection ports provides an opening from an interior surface to an exterior surface of the divergent section.

According to related aspects, a method for reducing jet noise from a turbofan engine with a convergent-divergent nozzle is provided. The method can include obtaining, from a source, one or more streams of gas to use as an injection gas. Moreover, the method may include managing one or more fluidic inserts in an exhaust flow from the turbofan engine created by injecting, at a divergent section of the convergent-divergent nozzle, the one or more streams of the injection gas into the exhaust flow.

Another aspect relates to an apparatus enabled to reduce jet noise from a convergent-divergent nozzle that includes a divergent section through which at least portion of an exhaust gas flows at supersonic speeds. The apparatus can include means for obtaining, from a source, one or more streams of gas to use as an injection gas. Moreover, the apparatus can include means for managing one or more fluidic inserts in an exhaust flow from the turbofan engine created by injecting, at the divergent section of the convergent-divergent nozzle, the one or more streams of the injection gas into the exhaust flow.

Another aspect relates to an apparatus enabled to reduce jet noise from a convergent-divergent nozzle that includes a divergent section through which at least portion of an exhaust gas flows at supersonic speeds. The apparatus can include one or more injection ports arranged on the divergent section of the convergent-divergent nozzle. In an aspect, each of the one or more injection ports may provide an opening from an interior surface to an exterior surface of the divergent section. Further, the apparatus may include one or more delivery pipes coupled to each of the one or more injection ports on the exterior surface side of the divergent section and operable to transport an injection gas from a source to the divergent section through the one or more injection ports. Moreover, the apparatus may include a controller operable to control at least one parameter associated with introduction of the injection gas.

Still another aspect relates to a computer program product, which can have a computer-readable medium including code for obtaining, from a source, one or more streams of gas to use as an injection gas. Moreover, the computer-readable medium can include code for managing one or more fluidic inserts in an exhaust flow from the turbofan engine created by injecting, at a divergent section of a convergent-divergent nozzle, the one or more streams of the injection gas into the exhaust flow.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

The disclosed aspects will hereinafter be described in conjunction with the appended drawings, provided to illustrate and not to limit the disclosed aspects, wherein like designations denote like elements, and in which:

FIG. 1 illustrates a profile view of a low bypass turbofan engine, according to an aspect;

FIG. 2 illustrates a profile view of a convergent-divergent nozzle, according to an aspect;

FIG. 3 illustrates a flowchart for operation of a fluidic insert based jet noise reduction scheme according to an aspect;

FIG. 4 illustrates a graphical representation of the effectiveness of a fluidic inserts based jet noise reduction scheme, according to an aspect;

FIG. 5 illustrates another graphical representation of the effectiveness of a fluidic insert based jet noise reduction scheme, according to an aspect; and

FIG. 6 illustrates a block diagram of an injection flow control system, according to an aspect.

### DETAILED DESCRIPTION

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As described herein, a combination of passive and active noise reduction methods for low bypass ratio turbofan engines may be used to reduce jet noise. In an aspect, passive methods may include, but are not limited to non-round nozzles, nozzles with beveled exit planes, etc. Further, as noted above, corrugated inserts have been shown to reduce noise while slightly improving nozzle performance. However, the corrugated inserts accomplished noise reduction with a single-point design and would be expected to degrade performance at other operating points, such as in cruise. Accordingly, the apparatus and method described herein replaces the mechanical (corrugated) inserts with “fluidic inserts.”

As used herein, “fluidic inserts” may refer to one or more streams of gas, such as but not limited to air obtained from a bypass flow, that are injected into an exhaust flow. In an aspect, the gas may be injected through one or more injection ports in a divergent section of a convergent-divergent nozzle. As used herein, each “injection port” may refer to an opening, such as but not limited to a substantially circular opening, a channel opening, a slot opening, an elliptical opening, etc., through which one or more streams of gas may flow into an exhaust flow. In an aspect, the flow rate used to generate the fluidic inserts may be within flow rates available from bypass flow presently used for wall cooling. In one operational aspect, the proposed noise reduction design may involve steady blowing. In another optional aspect, the proposed noise reduction design may involve varying flow rates and distribution to optimize performance.

As such, the noise reduction scheme described herein may be based on steady, distributed blowing to modify the effective area ratio and introduce stream-wise vorticity. The noise reduction scheme may also minimize or eliminate the broadband shock-associated noise and also increase mixing with an associated decrease in mixing noise in the peak noise direction. In an optional aspect, steady blowing may be modulated to further enhance turbulent mixing and decrease the radiated mixing noise.

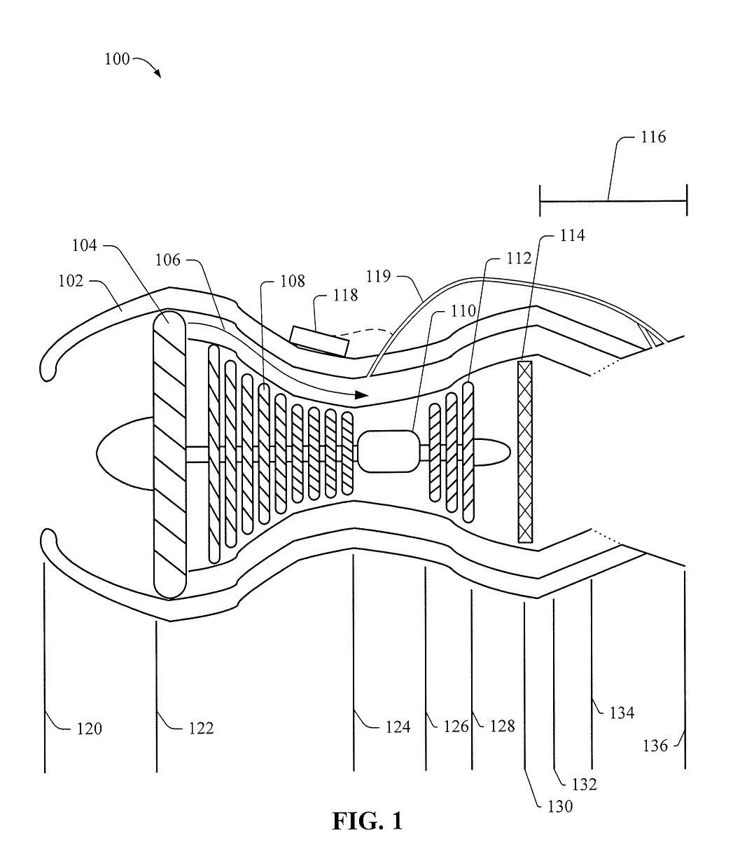

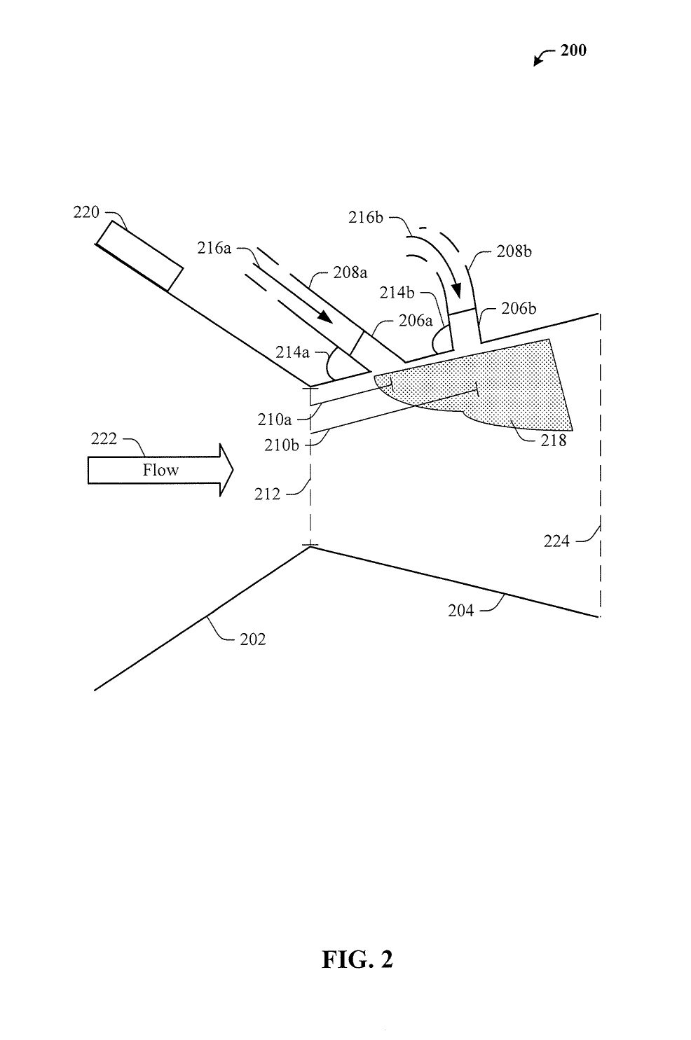

FIG. 1 illustrates a profile view of a low bypass turbofan engine 100. In the depicted aspect, an engine 100 may include an inlet 102, a fan 104, a compressor 108, a burner 110, a turbine 112, an afterburner 114 and a nozzle 116. In an aspect, engine 100 may further include one or more controllers 118 operable to manage the functionality of one or more components (e.g., 104, 108, 110, 112, etc.). Further, in one aspect, controller 118 may be operable to manage direction of a portion of a bypass flow 106 to the nozzle using one or more injection flow pipes 119. Further description of the nozzle 116 with injection flow pipes 119 is provided with reference to FIG. 2.

Further, locations along the engine 100 profile may be assigned station numbers. In one aspect, free stream conditions may be labeled 0 and the entrance to the inlet 102 is station 1 (120). The exit of the inlet 102, which may coincide with the beginning of the compressor 108, is labeled station 2 (122). The compressor 108 exit and burner 110 entrance is station 3 (124) while the burner 110 exit and turbine 112 entrance is station 4 (126). The exit of the turbine 112 is station 5 (128) and the flow conditions upstream of the afterburner 114 occur at station 6 (130). Station 7 (132) is at the entrance to the nozzle (116) and station 8 (134) is at the nozzle 116 throat. Some nozzles (e.g., convergent-divergent nozzles) include an additional section downstream of the throat at the nozzle (116) exit which is at station 9 (136).

Further, although a low bypass engine is depicted on FIG. 1, one or ordinary skill in the art would appreciate that the apparatuses and methods described herein may be applicable to other turbofan engine designs, e.g., high-bypass turbofan engines, etc.

While referencing FIG. 1, but turning also now to FIG. 2, an example nozzle architecture 200 is illustrated. Nozzle 200 may include a convergent section 202 and a divergent section 204.

Nozzle 200 may further include one or more injection ports (206a, 206b) that may be coupled to one or more injection pipes (208a, 208b) (e.g., injection pipe 119). Each injection port (206a, 206b) may be positioned at different distances (210a, 210b) along the divergent section, as measured from, for example, the throat 212. Additionally, each injection port may be angled at different angles (214a, 214b) with respect to the surface of the divergent segment 204. In an optional aspect, the surface of the divergent segment 204 may be non-uniform. By way of example and not limitation the surface of the divergent segment 204 may be substantially elliptical, may include one or more undulations/ridges, one or more openings, etc. In another operational aspect, injection port 206a may be positioned 210a approximately 20% along the length of the divergent section 204, and may provide the injected flow 216a at an angle 214a of 45 degrees with respect to an interior surface of the divergent section 204. In another operational aspect, injection port 206b may be positioned 210b approximately 70% along the length of the divergent section 204, and may provide the injected flow 216n at an angle 214b of 90 degrees with respect to an interior surface of the divergent section 204.

Further, although FIG. 2 only provides a profile view of a nozzle 200 with injection ports (206a, 206b) placed upon the profile axis, one or ordinary skill in the art would know that injection ports 206 may be placed at substantially any location around the surface of the divergent section 204 of the nozzle 200. For example, injections ports 206 may be placed at a top and a bottom of the nozzle 200. In such an example, the fluidic inserts 218 that may be formed may modify the shape of the exhaust flow (e.g., changing the exhaust flow from a substantially circular shape, to an oval shape). In another example, the decision of placement of injection ports 206 may be made based on minimizing jet noise at one or more flight conditions. In such an aspect, controller 220 may activate any combination of the injection ports 206 during each of the flight conditions.

In operation, an exhaust flow 222 may progress through the convergent section 202, through a throat 212, and into a divergent section 204. Additionally, one or more injection flows (216a, 218b) may be injected into the exhaust flow 222 using one or more injection pipes (208a, 208b) and one or more injection ports (206a, 206b). Such injected flows (216a, 218b) may generate a fluidic insert 218 in the exhaust flow 222. In such an aspect, the one or more fluidic inserts may be produced to result in an effective exhaust gas flow area at an exit of the divergent section 224, ratioed to a throat 212 area, to produce an exit pressure substantially equal to an atmospheric pressure. In an aspect, controller 220 may be operable to manage values such as, but not limited to, flow rates, modulation patterns, etc., for the injection flows (216a, 216b). Further, controller 220 may be operable to modify various injection flow 216 characteristics based on factors associated with operation of the nozzle 200 and engine 100. In another aspect, fluidic inserts may be used in combination with one or more other noise reduction schemes (e.g., corrugated mechanical inserts, chevrons, beveled nozzles, etc.).

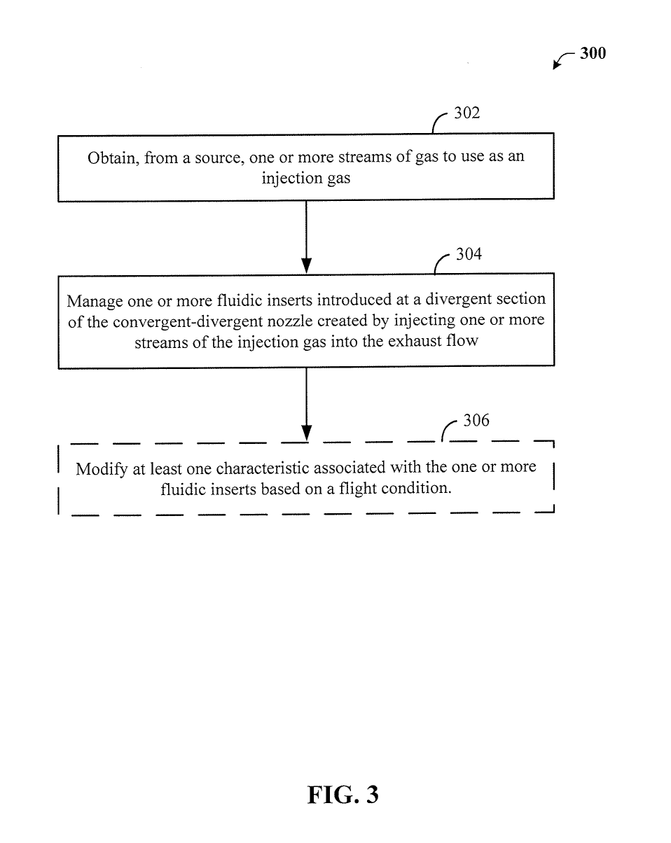

FIG. 3 illustrates various methodologies in accordance with various aspects of the presented subject matter. While, for purposes of simplicity of explanation, the methodologies are shown and described as a series of acts or sequence steps, it is to be understood and appreciated that the claimed subject matter is not limited by the order of acts, as some acts may occur in different orders and/or concurrently with other acts from that shown and described herein. For example, those skilled in the art will understand and appreciate that a methodology could alternatively be represented as a series of interrelated states or events, such as in a state diagram. Moreover, not all illustrated acts may be required to implement a methodology in accordance with the claimed subject matter. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 3 illustrates an example jet noise reduction process 300, according to an aspect.

At block 302, one or more streams of gas may be obtained from a source to be used as an injection gas. In one aspect, the source may be a bypass flow associated with the turbofan engine. In another aspect, the obtained injection gas may be provided to and/or transported through one or more delivery pipes to a nozzle. In such an aspect, a controller may control at least one parameter associated with introduction of the injection gas to the nozzle.

At block 304, the controller may manage one or more fluidic inserts introduced at a divergent section of the convergent-divergent nozzle. In an aspect, each fluidic insert may be created by injecting one or more streams of the injection gas into the exhaust flow. In an aspect, the controller may vary at least one parameter associated with introduction of the injection gas based on one or more flight conditions. In one aspect, the controller may provide different flow rates to different delivery pipes. In another aspect, the controller may control, change, introduce, etc., a modulation frequency of the injection flow.

At block 306, in an optional aspect, the controller may modify at least one characteristic associated with the one or more fluidic inserts. In one aspect, the controller may modify a flow rate at which the injection flow is introduced. In another aspect, the controller may change a modulation frequency of the injection flow. In still another aspect, the controller may allow different subsets of the one or more injection ports to be used during different flight conditions (e.g., take-off, cruise, landing, etc.).

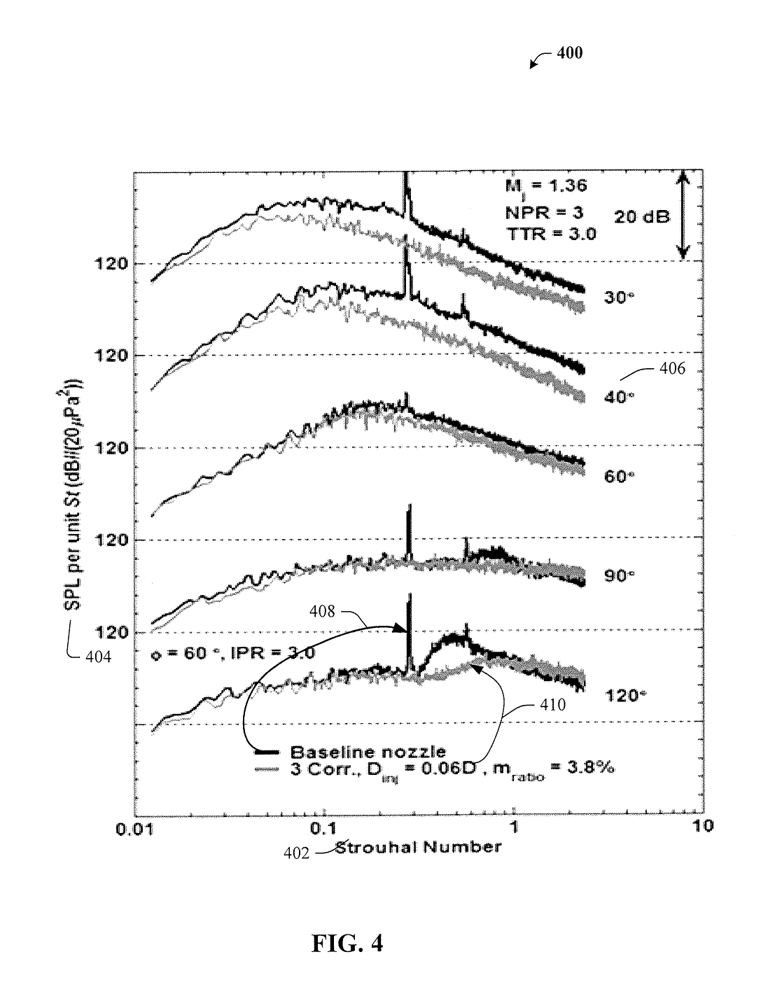

FIG. 4 provides a graphical representation 400 of experimental results associated with a fluidic insert noise reduction scheme.

Graph 400 shows Strouhal Number 402 values along the x-axis with sound pressure levels (SPL) 404 values along the y-axis. Further, graph 400 provides experimental results associated with different observer angles 406 around a nozzle. Graph 400 shows that when no flow injection is used to generate fluidic inserts 408 a greater SPL level is seen in comparison to a condition 410 in which fluidic inserts were generated. Further, the results represent a condition in which three fluidic inserts were used and spaced uniformly around the divergent section of the nozzle. The injector total pressure was set to be equal to the nozzle total pressure. Further, as the injector pressures are relative to the external ambient pressure, they operate with local pressure ratios in excess of 2.1 and hence produce supersonic jets at the wall of the nozzle flow. Graph 400 shows data recorded with a polar array of microphones in a plane halfway between two injectors.

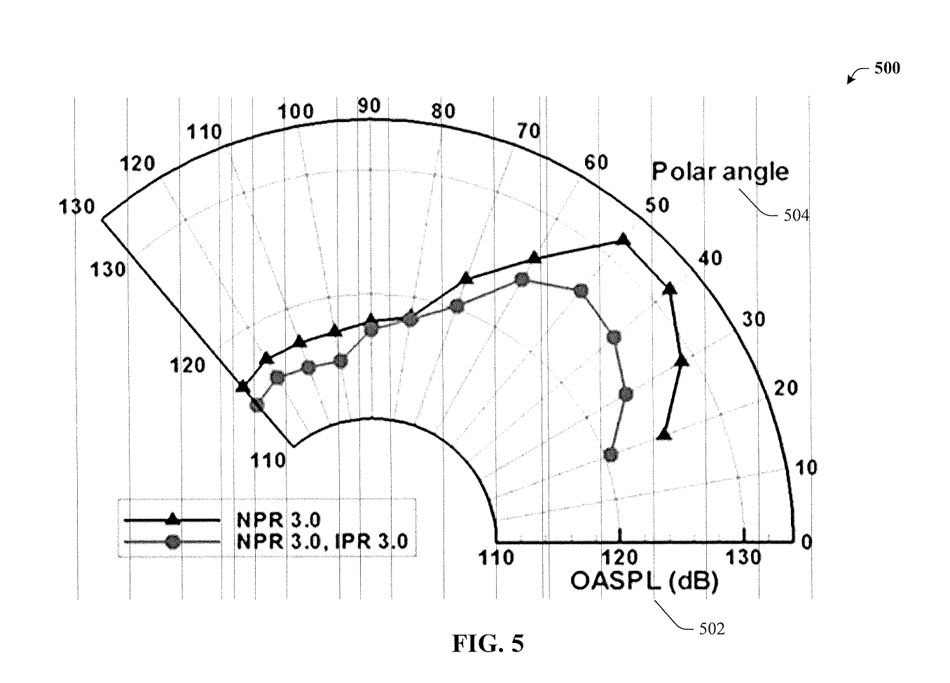

FIG. 5 provides another graphical representation 500 of experimental results associated with a fluidic insert noise reduction scheme.

Graph 500 provides overall sound pressure level (OASPL) (502) as a function of observer polar angle (504) relative to the downstream jet axis. In the depicted aspect, a design Mach number of Md-1.65 was used with a nozzle pressure ratio (NPR) of 3.0, and a total temperature ratio (TTR) of 3.0.

With respect to FIGS. 4 and 5, it is noted that for polar angles (406, 504) between 20 and 130 degrees from the jet downstream axis, noise benefits of approximately 5-6 dB may be achieved, with a benefit being the suppression of both broadband shock associated noise (e.g., at angles between 90 and 130 degrees) and turbulent mixing noise (e.g., at angles between 20 and 70 degrees).

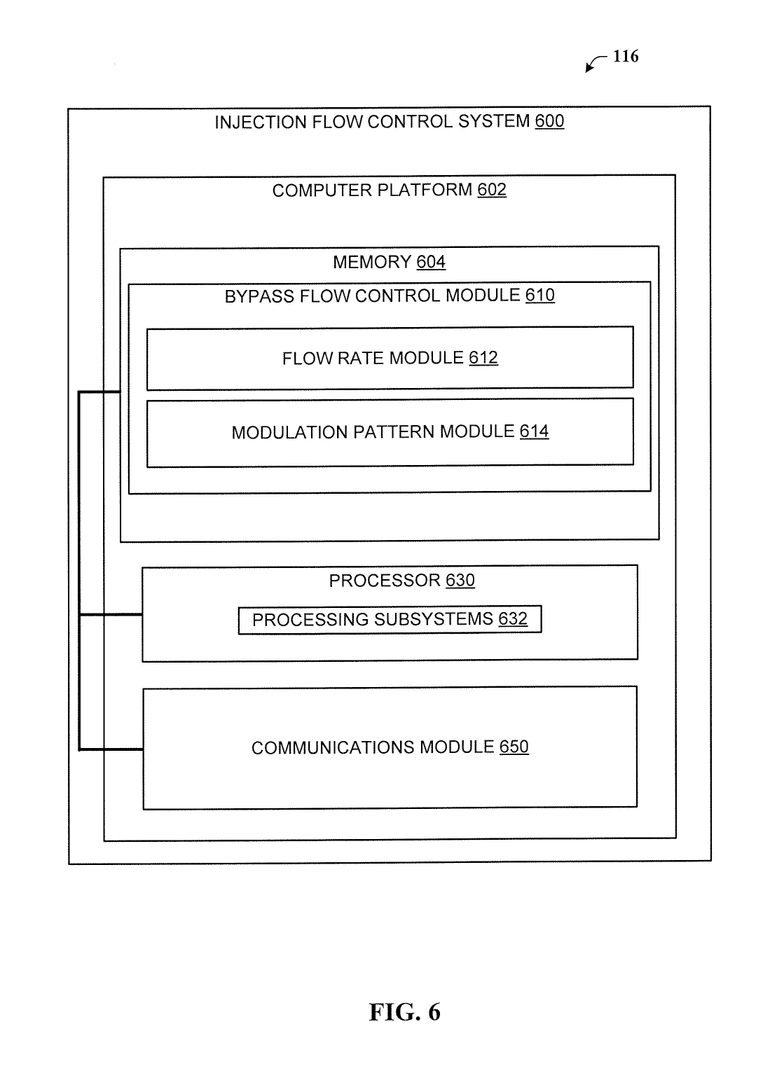

With reference to FIG. 6, illustrated is a detailed block diagram of an injection flow control system 600, such as controller 116 depicted in FIG. 1. Injection flow control system 600 may include at least one of any type of hardware, server, personal computer, mini computer, mainframe computer, or any computing device either special purpose or general computing device. Further, injection flow control system 600 may include any type of mechanical control components. Still further, the modules and applications described herein as being operated on or executed by injection flow control system 600 may be executed entirely on a single device, as shown in FIG. 6, or alternatively, in other aspects, separate servers, databases or computer devices may work in concert to provide data in usable formats to parties, and/or to provide a separate layer of control in the data flow between devices and the modules and applications executed by injection flow control system 600.

Injection flow control system 600 includes computer platform 602 that can transmit and receive data across wired and wireless networks, and that can execute routines and applications. Computer platform 602 includes memory 604, which may comprise volatile and nonvolatile memory such as read-only and/or random-access memory (ROM and RAM), EPROM, EEPROM, flash cards, or any memory common to computer platforms. Further, memory 604 may include one or more flash memory cells, or may be any secondary or tertiary storage device, such as magnetic media, optical media, tape, or soft or hard disk. Further, computer platform 602 also includes processor 630, which may be an application-specific integrated circuit (“ASIC”), or other chipset, logic circuit, or other data processing device. Processor 630 may include various processing subsystems 632 embodied in hardware, firmware, software, and combinations thereof, that enable the functionality of media content distribution system 14 and the operability of the network device on a wired or wireless network.

Processor 630, memory 604, bypass flow control module 610, and/or communications module 650 may provide means for obtaining, from a source, one or more streams of gas to use as an injection gas, and means for managing one or more fluidic inserts in an exhaust flow from the turbofan engine created by injecting, at a divergent section of the convergent-divergent nozzle, the one or more streams of the injection gas into the exhaust flow.

Computer platform 602 further includes communications module 650 embodied in hardware, firmware, software, and combinations thereof, that enables communications among the various components of injection flow control system 600, as well as between injection flow control system 600, and/or other devices. Communication module 650 may include the requisite hardware, firmware, software and/or combinations thereof for establishing a wireless and/or wired communication connection.

Memory 604 of injection flow control system 600 includes a bypass flow control module 610 operable to control one or more characteristics associated with introduction of an injection gas into a divergent section of a nozzle. Bypass flow control module 610 may include flow rate module 612, and modulation pattern module 614.

Flow rate module 612 may be operable to control one or more flow rates for injection gas that may be introduced using one or more delivery pipes. In an aspect, flow rate module 612 may vary flow rates based on different flight conditions. In another aspect, flow rate module 612 may restrict and/or stop flow to a subset of the one or more injection ports.

Modulation pattern module 614 may be operable to provide injection gases at one or more modulation frequencies. Further, modulation pattern module 614 may use different modulation frequencies for different injection streams. In another aspect, modulation pattern module 614 may change a modulation frequency based on one or more flight conditions.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program, and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Various aspects or features will be presented in terms of systems that may include a number of devices, components, modules, and the like. It is to be understood and appreciated that the various systems may include additional devices, components, modules, etc. and/or may not include all of the devices, components, modules etc. discussed in connection with the figures. A combination of these approaches may also be used.

The various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Additionally, at least one processor may comprise one or more modules operable to perform one or more of the steps and/or actions described above.

Further, the steps and/or actions of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium may be coupled to the processor, such that the processor can read information from, and write information to, the storage medium. In the alternative, the storage medium may be integral to the processor. Further, in some aspects, the processor and the storage medium may reside in an ASIC. Additionally, the ASIC may reside in a user terminal. In the alternative, the processor and the storage medium may reside as discrete components in a user terminal. Additionally, in some aspects, the steps and/or actions of a method or algorithm may reside as one or any combination or set of codes and/or instructions on a machine readable medium and/or computer readable medium, which may be incorporated into a computer program product.

In one or more aspects, the functions described may be implemented in hardware, software, firmware, or any combination thereof. If implemented in software, the functions may be stored or transmitted as one or more instructions or code on a computer-readable medium. Computer-readable media includes both computer storage media and communication media including any medium that facilitates transfer of a computer program from one place to another. A storage medium may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection may be termed a computer-readable medium. For example, if software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs usually reproduce data optically with lasers. Combinations of the above should also be included within the scope of computer-readable media.

While the foregoing disclosure discusses illustrative aspects and/or aspects, it should be noted that various changes and modifications could be made herein without departing from the scope of the described aspects and/or aspects as defined by the appended claims. Furthermore, although elements of the described aspects and/or aspects may be described or claimed in the singular, the plural is contemplated unless limitation to the singular is explicitly stated. Additionally, all or a portion of any aspect and/or aspect may be utilized with all or a portion of any other aspect and/or aspect, unless stated otherwise.

What is claimed is:

1. An apparatus for reduction of jet noise from a convergent-divergent nozzle that includes a divergent section through which at least portion of an exhaust gas flows at supersonic speeds, comprising:
one or more injection ports arranged on the divergent section of the convergent-divergent nozzle, wherein the each of the one or more injection ports provides an opening from an interior surface to an exterior surface of the divergent section;
one or more delivery pipes coupled to each of the one or more injection ports on the exterior surface side of the divergent section and operable to transport an injection gas from a source to the divergent section through the one or more injection ports; and
a controller operable to control at least one parameter associated with introduction of the injection gas.

2. The apparatus of claim 1, wherein the convergent-divergent nozzle is coupled to a low bypass ratio turbofan engine that includes a bypass flow, and wherein the source for the injection gas is the bypass flow.

3. The apparatus of claim 1, wherein the convergent-divergent nozzle is coupled to an aircraft, and wherein the controller is further operable to vary the at least one parameter associated with introduction of the injection gas based on one or more flight conditions.

4. The apparatus of claim 3, wherein the one or more flight conditions include at least one of: a take-off condition, a cruise condition, or a landing condition.

5. The apparatus of claim 1, wherein at least one of the one or more injection ports is positioned to provide the opening that is the substantially flush with the interior surface of the divergent section.

6. The apparatus of claim 1, wherein at least one of the one or more injection ports is orientated to provide the opening that is the substantially perpendicular to the interior surface of the divergent section.

7. The apparatus of claim 1, wherein at least one of the one or more injection ports is orientated to provide the opening that is at an angle with respect to the interior surface of the divergent section.

8. The apparatus of claim 1, wherein the one or more injection ports comprise a plurality of injection ports, and wherein the each injection port of the plurality of injection ports is arranged in an evenly distributed pattern radially around the divergent section.

9. The apparatus of claim 1, wherein the one or more injection ports comprise a plurality of injection ports, and wherein the each injection port of the plurality of injection ports is arranged in a pattern designed to minimize noise for at least one flight condition.

10. The apparatus of claim 1, wherein the controller is operable to provide different flow rates to different delivery pipes.

11. The apparatus of claim 1, wherein the controller is operable to provide a modulated injection gas flow.

12. The apparatus of claim 1, wherein the injection gas is injected into the exhaust gas flow to create one or more fluidic inserts.

13. The apparatus of claim 12, wherein the one or more fluidic inserts result in an effective exhaust gas flow area at an exit of the divergent section ratioed to a throat area that produces an exit pressure substantially equal to an atmospheric pressure.

14. A method of reducing jet noise from a turbofan engine with a convergent-divergent nozzle, comprising:
obtaining, from a source, one or more streams of gas to use as an injection gas; and
managing one or more fluidic inserts in an exhaust flow from the turbofan engine created by injecting, at a divergent section of the convergent-divergent nozzle, the one or more streams of the injection gas into the exhaust flow.

15. The method of claim 14, wherein the injecting further comprises injecting using a modulated injection gas flow.

16. The method of claim 14, wherein the injecting further comprises modifying a flow rate of the injection gas based on one or more flight conditions.

17. The method of claim 14, wherein the source is a bypass flow associated with the turbofan engine.

18. The method of claim 14, wherein the managing further comprises managing the fluidic inserts using a flow rate that results in an effective core flow area at the divergent section exit, ratioed to a throat area, that produces an exit pressure substantially equal to an atmospheric pressure.

19. A computer program product, comprising:
a computer-readable medium comprising code for:
obtaining, from a source, one or more streams of gas to use as an injection gas; and
managing one or more fluidic inserts in an exhaust flow from the turbofan engine created by injecting, at a divergent section of a convergent-divergent nozzle, the one or more streams of the injection gas into the exhaust flow.

20. An apparatus for reduction of jet noise from a convergent-divergent nozzle that includes a divergent section through which at least portion of an exhaust gas flows at supersonic speeds, comprising:
means for obtaining, from a source, one or more streams of gas to use as an injection gas; and
means for managing one or more fluidic inserts in an exhaust flow from the turbofan engine created by injecting, at the divergent section of the convergent-divergent nozzle, the one or more streams of the injection gas into the exhaust flow.
